(19) United States
(12) Patent Application Publication
(10) Pub. No.: US 2013/0135274 A1
(43) Pub. Date: May 30, 2013

(54) Organic Light-emitting Display Device and Method of Manufacturing the Same

(71) Applicants: Jung-Mi Choi, Yongin-City (KR); Young-In Hwang, Yongin-City (KR)

(72) Inventors: Jung-Mi Choi, Yongin-City (KR); Young-In Hwang, Yongin-City (KR)

(73) Assignee: SAMSUNG MOBILE DISPLAY CO., LTD., Yongin-City (KR)

(21) Appl. No.: 13/476,803

(22) Filed: May 21, 2012

(30) Foreign Application Priority Data
Nov. 30, 2011 (KR) 10-2011-0127254

(51) Int. Cl. G09G 3/30; H01J 9/20; G09G 5/00

(52) U.S. Cl. 345/211; 445/24; 345/76

(57) ABSTRACT

In an organic light-emitting display device and a method of manufacturing the same, the organic light-emitting display device comprises: a plurality of pixels, each including an electroluminescence (EL) device and a thin film transistor (TFT); and a power voltage supply line for applying a voltage to the TFT of each pixel. The power voltage supply line is divided into two lines disposed at respective sides of each pixel. An area where a power voltage supply line overlaps with another line is reduced, and thus the possibility that a short circuit may occur between the power voltage supply line and another line is decreased, thereby reducing a defect percentage of the product.

### CLAIM OF PRIORITY

This application makes reference to, incorporates the same herein, and claims all benefits accruing under 35 U.S.C. §119 from an application earlier filed in the Korean Intellectual Property Office on the 30^{th} of November 2011 and there duly assigned Serial No. 10-2011-0127254.

### BACKGROUND OF THE INVENTION

1. Field of the Invention

The present invention relates to an organic light-emitting display device having an improved structure of a power voltage supply line which may easily prevent generation of a short circuit, and a method of manufacturing the organic light-emitting display device.

2. Description of the Related Art

In general, organic light-emitting display devices include a thin film transistor (TFT), an electroluminescence (EL) device which is driven by the TFT and forms an image, and the like. In other words, if a current is supplied to the EL device through the TFT, light-emission occurs in the EL device, thereby forming an image.

Meanwhile, in the organic light-emitting display device, various lines connected to the TFT are formed in a plurality of layers. Among the lines, a power voltage supply line referred to as an ELVdd line is formed so as to have a relatively large width compared to other lines.

However, if the ELVdd line having a relatively large width is formed, a range of an area where the ELVdd line overlaps with another line disposed in a different layer is widened accordingly, thereby resulting in a much higher risk of generation of a short circuit between lines. In particular, generation of a short circuit between the power voltage supply line and a global control line, which crosses the power voltage supply line and is disposed in an adjacent layer, has been a big problem.

Accordingly, there is a need to develop a measure to effectively reduce the risk of generation of a short circuit between the power voltage supply line and the global control line.

### SUMMARY OF THE INVENTION

The present invention provides an organic light-emitting display device having an improved structure of a power voltage supply line which may easily prevent generation of a short circuit, and a method of manufacturing the organic light-emitting display device.

According to an aspect of the present invention, there is provided an organic light-emitting display device comprising: a plurality of pixels, each including an electroluminescence (EL) device and a thin film transistor (TFT); and a power voltage supply line for applying a voltage to the TFT of each pixel; wherein the power voltage supply line is divided into two lines so as to be disposed at both sides of each pixel.

The power voltage supply line may include a first ELVdd line and a second ELVdd line which are disposed at both sides around each pixel.

The organic light-emitting display device may further include a mesh line for electrically connecting the first ELVdd line and the second ELVdd line to each other.

The organic light-emitting display device may further include a global control line which has an area overlapping with the power voltage supply line, and which is disposed in an adjacent layer.

The global control line may overlap any of the first ELVdd line and the second ELVdd line.

According to another aspect of the present invention, there is provided a method of manufacturing an organic light-emitting display device, the method comprising: forming a plurality of pixels, each comprising an EL device and a TFT, on a substrate; and forming a power voltage supply line divided into two lines so as to be disposed at both sides of each pixel in order to apply a voltage to the TFT of each pixel.

The power voltage supply line may include a first ELVdd line and a second ELVdd line which are disposed at both sides around each pixel.

The method may further include forming a mesh line for electrically connecting the first ELVdd line and the second ELVdd line to each other.

The method may further include forming a global control line which has an area overlapping the power voltage supply line, and which is disposed in an adjacent layer.

The global control line may overlap any of the first ELVdd line and the second ELVdd line.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a circuit diagram of a line in one pixel of an organic light-emitting display device; and

FIG. 2 is a plan view of an organic light-emitting display device according to an embodiment of the present invention.

### DETAILED DESCRIPTION OF THE INVENTION

Hereinafter, exemplary embodiments of the present invention will be described in detail with reference to the attached drawings. Like reference numerals designate like elements throughout the specification. In the description, the detailed descriptions of well-known functions and structures may be omitted so as not to hinder an understanding of the present invention.

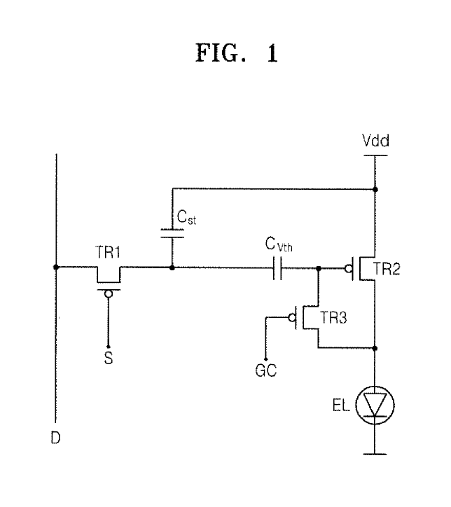

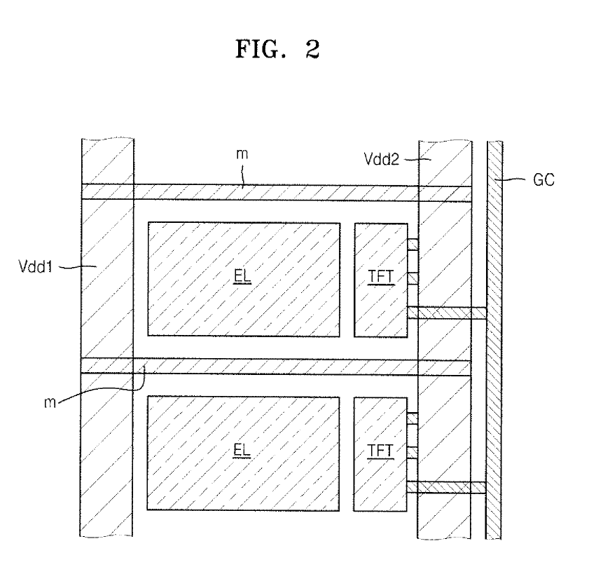

FIG. 1 is a circuit diagram of a line in one pixel of an organic light-emitting display device; and FIG. 2 is a plan view of an organic light-emitting display device according to an embodiment of the present invention.

Referring to FIG. 1, each pixel includes a first thin film transistor TR1 which is used as a switch, a second thin film transistor TR2 which is used as a driving element, a third thin film transistor TR3 which provides a compensation signal, capacitors Cst and Cvth which are storage elements, and an electroluminescence (EL) device EL which is driven by the first to third thin film transistors TR1 to TR3, respectively. The number of first to third thin film transistors TR1 to TR3, respectively, and the number of capacitors Cst and Cvth are not limited thereto, and a greater number of first to third thin film transistors TR1 to TR3, respectively, and capacitors Cst and Cvth, respectively, may be employed.

Hereinafter, functions of the thin film transistors will be described. First, the first thin film transistor TR1 is driven according to a scan signal applied to a scan line S, and it transmits a data signal applied to a data line D.

The second thin film transistor TR2 determines an amount of current supplied to the electroluminescence device EL via the power voltage supply line Vdd according to the data signal transmitted via the first thin film transistor TR1.

The third thin film transistor TR3 is connected to a global control line GC so as to compensate a threshold voltage.

FIG. 2 is a schematic plan view showing the first to third thin film transistors TR1 to TR3, respectively, of FIG. 1, the power voltage supply line Vdd, and the global control line GC which are disposed on a substrate of the organic light-emitting display device.

Specifically, reference numeral TFT denotes an area where a thin film transistor, including the first to third thin film transistors TR1 to TR3, respectively, and the capacitors Cst and Cvth, is disposed. Reference numeral EL denotes the electroluminescence device. The electroluminescence device EL and the thin film transistor TFT are connected to each other in actuality, but the electroluminescence device EL and the thin film transistor TFT are shown as schematic individual blocks in FIG. 2.

Reference numeral GC denotes a global control line connected to the third thin film transistor TR3 of the thin film transistor TFT as described above, and reference numerals Vdd1 and Vdd2 denote power voltage supply lines.

In this regard, the power voltage supply lines are disposed as a first ELVdd line Vdd1 and a second ELVdd line Vdd2, respectively, at both sides of a pixel including the electroluminescence device EL and the thin film transistor TFT, as shown in FIG. 2. In other words, the power voltage supply lines passing through edges of the pixel are not formed as single lines, and are formed as the first ELVdd line Vdd1 and the second ELVdd line Vdd2 which are separately disposed at both sides of the pixel on an actual substrate.

The first ELVdd line Vdd1 and the second ELVdd line Vdd2 are electrically connected to each other via a mesh line m which is disposed perpendicularly with respect to the first and second ELVdd lines Vdd1 and Vdd2, respectively. Accordingly, the power voltage supply lines are separately disposed as the first ELVdd line Vdd1 and the second ELVdd line Vdd2 at both sides of the pixel so as to be connected to each other via the mesh line m, thereby substantially controlling the first and second ELVdd lines Vdd1 and Vdd2, respectively, as a single line.

As such, the reason why the power voltage supply line is divided into the first ELVdd line Vdd1 and the second ELVdd line Vdd2 at both sides of the pixel is to reduce an area where the first and second ELVdd lines Vdd1 and Vdd2, respectively, overlap with a line crossing the power voltage supply line and connected to the thin film transistor TFT, like the global control line GC.

In other words, as described above, the power voltage supply lines have the largest widths among lines included in the organic light-emitting display device, and thus there is a relatively high possibility that a short circuit may occur between the power voltage supply line and another line of an adjacent layer overlapped with the layer in which the power voltage supply line is disposed. However, since a conventional organic light-emitting display device has a structure in which a single line having a width corresponding a sum of a width of the first ELVdd line Vdd1 and a width of second ELVdd line Vdd2 is formed between the thin film transistor TFT and the global control line GC of the pixel, an area where the first and second ELVdd lines Vdd1 and Vdd2, respectively, overlap with the global control line GC crossing the first and second ELVdd lines Vdd1 and Vdd2, respectively, is widened accordingly. Accordingly, a possibility that a short circuit may occur between the first and second ELVdd lines Vdd1 and Vdd2, respectively, and the global control line GC is increased. However, as shown in the structure of the organic light-emitting display device of the present invention, if the power voltage supply line is disposed so as to be divided into the first ELVdd line Vdd1 and the second ELVdd line Vdd2, an area where the power voltage supply line overlaps with the global control line GC is reduced by half.

Thus, the possibility that a short circuit may occur between the first and second ELVdd lines Vdd1 and Vdd2, respectively, and the global control line GC is reduced by half, thereby guaranteeing a stable quality of a product.

In manufacturing the organic light-emitting display device having the above-described structure, the global control line GC is first formed, and then the power voltage supply lines are formed on the global control line GC by interposing an insulating layer (not shown) therebetween. In this instance, as described above, among the power voltage supply lines, only the second ELVdd line Vdd2 overlaps with the global control line GC, thereby manufacturing a stable organic light-emitting display device in which the possibility of generation of a short circuit is greatly decreased.

Also, if the power voltage supply line is disposed so as to be divided into the first and second ELVdd lines Vdd1 and Vdd2, respectively, a selective crystallizing operation with respect to an active layer may be easily performed. That is, during manufacturing of the organic light-emitting display device, a crystallizing operation is performed with respect to the active layer included in the thin film transistor TFT. In general, a selective crystallizing operation is performed with respect to remaining areas other than an area of the electroluminescence device EL which is a light-emitting unit. In this instance, as described in the current embodiment, if the power voltage supply line is disposed so as to be divided into the first and second ELVdd lines Vdd1 and Vdd2, respectively, the width of an area where the crystallizing operation is performed is relatively reduced. Accordingly, operating time is reduced, thereby reducing a protruding defect resulting from a crystallization protrusion which is too large.

Also, if the power voltage supply line is disposed so as to be divided into the first and second ELVdd lines Vdd1 and Vdd2, respectively, a repairing operation may be easily performed. That is, even if a short circuit occurs in a certain point of the first and second ELVdd lines Vdd1 and Vdd2, respectively, since the first and second ELVdd lines Vdd1 and Vdd2, respectively, are separately disposed, a number of paths for taking a measure is increased accordingly, and thus a repairing operation may be easily performed.

According to the present invention, the above-described organic light-emitting display device is configured in such a way that an area where the power voltage supply line overlaps with another line is reduced, and thus the possibility that a short circuit may occur between the power voltage supply line and another line is decreased, thereby reducing a percentage of defect of the product.

While the present invention has been particularly shown and described with reference to exemplary embodiments thereof, it will be understood by those of ordinary skill in the art that various changes in form and detail maybe made therein without departing from the spirit and scope of the present invention as defined by the following claims.

What is claimed is:

1. An organic light-emitting display device, comprising:
a plurality of pixels, each comprising an electroluminescence (EL) device and a thin film transistor (TFT); and
a power voltage supply line for applying a voltage to the TFT of each pixel;
wherein the power voltage supply line is divided into two lines, each disposed at a respective side of each pixel.

2. The organic light-emitting display device of claim 1, wherein the power voltage supply line comprises a first ELVdd line and a second ELVdd line, each disposed at a respective side around each pixel.

3. The organic light-emitting display device of claim 2, further comprising a mesh line for electrically connecting the first ELVdd line and the second ELVdd line to each other.

4. The organic light-emitting display device of claim 2, further comprising a global control line having an area overlapping with the power voltage supply line, said global control line being disposed in an adjacent layer.

5. The organic light-emitting display device of claim 4, wherein the global control line overlaps with at least one of the first ELVdd line and the second ELVdd line.

6. A method of manufacturing an organic light-emitting display device, the method comprising the steps of:
forming a plurality of pixels, each comprising an EL device and a TFT, on a substrate; and
forming a power voltage supply line divided into two lines disposed at respective sides of each pixel for applying a voltage to the TFT of each pixel.

7. The method of claim 6, wherein the power voltage supply line comprises a first ELVdd line and a second ELVdd line disposed at respective sides around each pixel.

8. The method of claim 7, further comprising the step of forming a mesh line for electrically connecting the first ELVdd line and the second ELVdd line to each other.

9. The method of claim 7, further comprising the step of forming a global control line having an area overlapping with the power voltage supply line and disposed in an adjacent layer.

10. The method of claim 9, wherein the global control line overlaps with at least one of the first ELVdd line and the second ELVdd line.
